(19) United States
(12) Patent Application Publication
(10) Pub. No.: US 2018/0179119 A1
(43) Pub. Date: Jun. 28, 2018

(54) High Temperature Energetic Formulations

(71) Applicants: Superior Energy Services, LLC, Harvey, LA (US); Los Alamos National Security, LLC, Los Alamos, NM (US)

(72) Inventors: Barry K. Holder, Montgomery, TX (US); Gabriel Avilucea, Los Alamos, NM (US); Philip Leonard, Los Alamos, NM (US)

(21) Appl. No.: 15/849,281

(22) Filed: Dec. 20, 2017

Related U.S. Application Data
(60) Provisional application No. 62/438,910, filed on Dec. 23, 2016.

(51) Int. Cl. C06B 45/10; C06B 29/08; C09K 8/70; E21B 43/263

(52) U.S. Cl. CPC C06B 45/10; E21B 43/263; C09K 8/70; C06B 29/08

(57) ABSTRACT

A formulation for a composite propellant including an oxidant suspended or embedded in a binder matrix, and the binder matrix having a cured or partially cured binder precursor including two or more functional groups.

### CROSS-REFERENCE TO RELATED APPLICATION

This application claims the benefit under 35 USC 119(e) to U.S. provisional application Ser. No. 62/438,910 filed Dec. 23, 2016, which is incorporated by reference herein in its entirety.

### STATEMENT REGARDING FEDERALLY SPONSORED RESEARCH OR DEVELOPMENT

The United States government has certain rights in this invention pursuant to Contract No. DE-AC52-06NA25396 between the United States Department of Energy and Los Alamos National Security, LLC for the operation of Los Alamos National Laboratory.

### BACKGROUND

Extraction of underground oil and gas resources, including extraction by hydraulic fracturing (e.g., fracking), generally includes a well completion step in which the walls of the bore hole are perforated and cracks are formed in the surrounding rock to thereby provide a path for hydrocarbons to flow into the center of the bore hole. Currently used methods of oil well completion involve loading and detonating a perforating gun within the bore hole, followed by hydrostatic loading of a fluid such as water to further extend the resulting rock fractures. However, the process of loading a detonating gun into a bore hole is dangerous and expensive, and currently used detonating guns often do not adequately “stimulate” or trigger oil flow in the well. These limitations lower the efficiency of well completion.

### BRIEF DESCRIPTION OF DRAWINGS

FIG. 1 illustrates one embodiment of a stimulation tool of the present invention.

### DETAILED DESCRIPTION

One or more aspects of embodiments of the present disclosure are directed toward composite propellants, and methods of producing composite propellants. A composite propellant according to embodiments of the present disclosure can be placed down hole (e.g., in a bore hole or oil/gas well) and will remain stable over a period of weeks to months at the high temperatures present in the bore hole. According to embodiments of the present disclosure, the composite propellant is formulated to release a rapid pulse of gas upon ignition that can open or enlarge fractures in the surrounding rock, thereby enabling oil/gas extraction from nearby deposits via the bore hole.

Conventional composite propellants are typically not designed to withstand high temperatures. As used herein, the term “high temperature” denotes a temperature above about 100° C. In some embodiments, for example, a high temperature may be about 100° C. to about 150° C., or a temperature above 150° C. However, according to embodiments of the present disclosure, the composite propellants are designed to have high thermal stability, e.g., to be able to withstand a temperature over 150° C. for at least 1 hour.

In addition, conventional high performance explosives typically include explosive ingredients, i.e., ingredients that are designed to produce an explosion (e.g., a pressure shockwave) with high shattering power, or high brisance. According to embodiments of the present disclosure, however, the composite propellants have low brisance in order to avoid or reduce the amount of unproductive shattering of rock into powder or sediment, which could fill or partially fill the rock fractures generated in the explosion and thereby prevent or reduce the flow of hydrocarbons into the bore hole.

Further, the composite propellants according to embodiments of the present disclosure deflagrate, and are resistant to deflagration to detonation transition (DDT). As used herein, the term “deflagration” is used in its art-recognized sense to refer to combustion that propagates through a material at subsonic speeds (i.e., slower than the speed of sound in rock, e.g., less than about 400 m/sec). The term “detonation” is used in its art-recognized sense to refer to combustion that propagates through a material at supersonic speeds (i.e., faster than the speed of sound in rock, e.g., greater than about 400 m/sec) so that a shock front propagates through the material in advance of the exothermic front of the combustion reaction. When the above parameters are satisfied, the composite propellants according to embodiments of the present disclosure may be particularly suitable for use in oil well completion.

According to one or more aspects of embodiments of the present disclosure, a formulation for a composite propellant includes an oxidant suspended or embedded in a binder matrix, the binder matrix including a cured or partially cured binder precursor having two or more functional groups.

The oxidant may be any material capable of oxidizing the other components in the composite propellant. In some embodiments, the oxidant may be any material capable of receiving electrons from and/or transferring at least one oxygen atom to an acceptor molecule. The electron transfer and/or oxygen atom transfer reaction, also known as oxidation, may be accompanied by a rapid release of energy in the form of heat, as well as gaseous products such as nitrogen (N2) and hydrochloric acid (HCI).

The oxidant may be an inorganic oxidant, and in some embodiments, may be a salt compound including a cation and an anion. The anion may be a nitrate anion, a perchlorate anion, a chlorate anion, a permanganate anion, a peroxide anion, or a mixture thereof. The cation may be an alkali metal cation (such as Lit, Na+, K+, Rb+, and Cs+), an alkaline earth metal cation (such as Be2+, Mg2+, Ca2+, Sr2+, and Ba2+), a transition metal cation (such as any cation selected from the metals of Groups 3-12), an ammonium cation or other quaternary amine (such as NR4+, where each R is an alkyl or aryl group), or a mixture thereof. For example, the oxidant may include sodium perchlorate, potassium perchlorate, ammonium perchlorate, sodium nitrate, potassium nitrate, ammonium nitrate, zinc nitrate, or a mixture thereof. It will be understood that although embodiments of the present disclosure in which the oxidant is a perchlorate compound or a nitrate compound are described herein, the scope of the present disclosure is not limited thereto, and those of ordinary skill in the art are capable of selecting other suitable oxidants according to the principles described herein.

The oxidant may be present in the formulation as solid particles that are suspended in the binder during mixing. The size of the oxidant particles is not particularly limited, and may be any suitable size capable of being suspended in the binder. In some embodiments, for example, the diameter of the particles may be about 325 mesh (about 44 pm) to about 650 pm; about 200 mesh (about 74 pm) to about 500 pm; or about 125 pm to about 350 pm, but embodiments of the present disclosure are not limited thereto. The particle size distribution is also not particularly limited, and may be any suitable distribution capable of being suspended in the binder. For example, the oxidant may have one average particle diameter (e.g., a monomodal particle size distribution), or it may have two or more different average particle diameters (e.g., a multimodal distribution). In either case, the oxidant may include a single oxidant species, or a mixture of oxidant species. In embodiments in which the oxidant includes more than one oxidant species, each species may have a similar particle size such that the oxidant as a whole has a single average particle size (e.g., a monomodal particle size distribution). Alternatively, each species of the oxidant may have a different average particle size, such that the oxidant as a whole has two or more different average particle diameters (e.g., a multimodal distribution).

The oxidant may be present in the formulation for the composite propellant in an amount of about 50 wt % to about 85 wt % based on 100 wt % of the formulation for the composite propellant. For example, in some embodiments, the oxidant may be present in an amount of about 55 wt % to about 80 wt %, or about 60 wt % to about 70 wt % based on 100 wt % of the formulation for the composite propellant.

As noted above, in some embodiments, the oxidant is suspended in the binder in the formulation for the composite propellant. For example, the binder may form a solid elastomeric matrix that provides the composite propellant with a consistency and/or viscosity that allows the composite propellant to be formed into, and to maintain a desired shape. The matrix serves to contain (or suspend) the oxidant in addition to any other components of the formulation. In some embodiments, for example, the oxidant (and any other formulation components) may be embedded in the matrix of the binder. Moreover, the binder may assist in stabilizing the oxidant and any other reactive components, for example, by absorbing unwanted incidental energy inputs such as impact, friction, electrical spark, mechanical shock, and heat. In some embodiments, the binder may serve as a fuel for the oxidant during detonation, and may produce large amounts of gas (e.g., 002, CO, and H2O vapor) that may add to the force generated by the propellant upon detonation.

The binder may be an energetic binder, an inert binder, or a combination thereof. As used herein, the term “energetic binder” is used in its art-recognized sense to refer to a binder that serves as a source of gases and energy from decomposition of functional groups with large heats of formation (such as the azide moiety (—N3)). The gases and energy are released upon detonation of the composite propellant and decomposition of the binder. Additionally, as used herein, the term “inert binder” refers to a binder that does not incorporate energetic functional groups (such as azide, nitrate ester, etc.).

The binder may be initially provided in the formulation as a liquid or flowable binder precursor that is converted into a solid polymer, a resin, or a mixture thereof via a polymerization or curing reaction. The polymerization or curing reaction and/or the components of the binder may be selected so that the reaction may be initiated by a suitable trigger, and/or so that the kinetics (e.g., timescale or rate) of the reaction may be suitable for further processing and/or deployment of the composite propellant. In some embodiments, for example, the binder may be selected so that the curing reaction is initiated when an additional component is added. In some embodiments, the binder may be selected so that the curing reaction occurs radually, and the composite propellant can be formed into a desired shape before it becomes completely solidified. In some embodiments, the rate of the curing reaction may be affected by the use of elevated temperature or the addition of a catalyst.

The binder precursor may be included in the formulation for the composite propellant in an amount of about 5 wt % to about 32 wt % based on 100 wt % of the composite propellant. In some embodiments, for example, the binder precursor may be included in an amount of about 12 wt % to about 28 wt %, or about 20 wt % to about 25 wt % based on 100 wt % of the formulation for the composite propellant. When the binder precursor undergoes two or more kinds of polymerization or curing reactions, the amount of binder precursor may be decreased relative to a binder precursor that undergoes one kind of polymerization or curing reaction. In some embodiments, for example, the binder precursor may be included in an amount of about 5 wt % to about 22 wt %, or about 5 wt % to about 15 wt %.

The liquid or flowable binder precursor may include a monomer, an oligomer, or a combination thereof. The monomer or the oligomer may each be a single monomer or oligomer, or a mixture of different monomers or oligomers. The monomers and/or oligomers may each include two or more functional groups (e.g., at least two functional groups) that are able to intermolecularly react with functional groups on other monomers, oligomers, or other molecules present in the formulation for the composite propellant to thereby polymerize or assemble a three-dimensional elastomeric network via the formation of one or more new bonds (e.g., cure). Non-limiting examples of suitable functional groups include vinyl groups, alcohol groups, ether groups, epoxy groups, acryloyl groups, azide groups, nitrile groups, isocyanate groups, and alkoxy groups.

In some embodiments, the two or more functional groups may all be the same type or kind of functional group. In some embodiments, for example, the binder precursor may include one or more hydroxy groups (e.g., may be a polyol compound). In some embodiments, the binder precursor may include one or more azide groups (e.g., may be a polyazide compound). When the binder precursor includes a single type or kind of functional group, the binder precursor may participate in a single type or kind of polymerization reaction.

In some embodiments, the two or more functional groups may be independently selected from different types or kinds of functional groups (e.g., may include a mixture of functional groups). For example, the binder precursor may include a mixture of hydroxy and azide groups, e.g., one or more hydroxy groups in addition to one or more azide groups. In some embodiments, when the binder precursor includes hydroxy groups and azide groups, the hydroxy groups may participate in one coupling or polymerization reaction, while the azide groups may participate in an independent, orthogonal coupling or polymerization reaction. However, embodiments of the present disclosure are not limited thereto, and those of ordinary skill in the art are capable of selecting appropriate or suitable binder precursor functional groups according to the desired reactivity and resultant polymer structure.

The monomer and/or oligomer may each include a non-reactive group or atomic chain that serves as the skeleton or scaffold for the two or more functional groups. The two or more functional groups may be commonly bonded to the non-reactive group or atom (e.g., a central non-reactive group or atom) that does not directly participate in any coupling reaction. The non-reactive group may be an aliphatic group (e.g., an alkyl group, an alkene group, or an alkyne group), an aromatic group, or a combination thereof. In some embodiments, the non-reactive group may contain a heteroatom such as Si, N, 0, S, etc. Non-limiting examples of suitable non-reactive groups include silyl groups and heteroaromatic groups.

In some embodiments, the binder precursor may include a hydroxyl-terminated dimethyl polysiloxane (PDMS) including one or more hydroxy functional groups. When the binder precursor includes PDMS, the binder precursor may be included in the formulation for the composite propellant in an amount of about 5 wt % to about 25 wt % based on 100 wt % of the formulation for the composite propellant. In some embodiments, for example, the binder precursor may be included in an amount of about 10 wt % to about 18 wt %, or about 12 wt % to about 15 wt % based on 100 wt % of the formulation for the composite propellant.

In some embodiments, the binder precursor may include a glycidyl azide polymer (GAP) including one or more hydroxy functional groups and one or more azide functional groups. Either or both of the hydroxyl and azide functional groups may participate in polymerization reactions as the composite propellant is formed. When the binder includes GAP, the binder precursor may be included in the formulation for the composite propellant in an amount of about 5 wt % to about 32 wt % based on 100 wt % of the composite propellant. In some embodiments, for example, the binder precursor may be included in an amount of about 12 wt % to about 28 wt %, or about 20 wt % to about 25 wt % based on 100 wt % of the formulation for the composite propellant.

Non-limiting examples of binder precursors include the hydroxyl-terminated dimethyl polysiloxane (PDMS) and glycidyl azide polymers (GAP) mentioned above, as well as R45M hydroxyl-terminated polybutadiene (HTPB), polybutadiene acrylonitrile (PBAN), and mixtures thereof, including mixtures with earlier described binders. Each individual binder precursor may be included in an amount of about 5 wt % to about 20 wt % based on 100 wt % of the formulation, and in some embodiments about 10 wt % to about 15 wt % based on 100 wt % of the formulation, where the total amount of binder precursor may be within the ranges described above. In some embodiments, the binder precursor may include a mixture of GAP and PBAN.

In some embodiments, the formulation for the composite propellant may further include a crosslinker. As used herein, the term “crosslinker” is used to refer to a component including two or more functional groups that are each able to participate in intermolecular bond-forming reactions, or coupling reactions, with other components of the formulation. When included, the crosslinker thus acts as a mutual point of connection between two or more component molecules of the formulation, e.g., two or more component molecules of the binder, such as the monomer and/or oligomer. The functional groups on the crosslinker may be selected so that they complement (e.g., react with) the functional groups on the binder precursor molecules. The functional groups may be the same or different from each other, and may be bonded to the same atom or different atoms of the crosslinker. However, embodiments of the present disclosure are not limited thereto, and suitable crosslinkers and crosslinker structures may be selected according to the desired curing reactions and structure of the cured binder precursor. In addition, formulations for composite propellants without a crosslinker are expressly included within the scope of the invention.

The crosslinker may be included in the formulation for the composite propellant in an amount of about 1 wt % to about 15 wt % based on 100 wt % of the formulation for the composite propellant. In some embodiments, for example, the crosslinker may be included in an amount of about 2 wt % to about 13 wt %, or about 4 wt % to about 10 wt % based on 100 wt % of the formulation for the composite propellant.

The crosslinker may include a non-reactive group or atom that serves as the skeleton or scaffold for the two or more functional groups of the crosslinker. The two or more functional groups may be commonly bonded to a central non-reactive group of the crosslinker that does not directly participate in any coupling reaction. The non-reactive group of the crosslinker may be an aliphatic group (e.g., an alkylene group, an alkenylene group, or an alkynylene group), an aromatic or aryl group, or a combination thereof. In some embodiments, the non-reactive group of the crosslinker may contain a heteroatom such as Si, N, 0, S, etc. Non-limiting examples of suitable crosslinkers include silyl groups and heteroaromatic groups.

In some embodiments, the crosslinker may include a polyisocyanate, i.e., the crosslinker may include two or more isocyanate groups (e.g., a N=C=0 moiety) bonded to a central non-reactive group. For example, the crosslinker may include a diisocyanate, a triisocyanate, etc. When the crosslinker includes a polyisocyanate and the binder precursor includes one or more hydroxy groups (e.g., the binder precursor is a polyol compound), the binder precursor hydroxy groups may each react with one of the isocyanate groups of the crosslinker to thereby form a urethane linkage (e.g., NH—(C=0)0-) via nucleophilic attack of the hydroxy oxygen on the carbon atom of the isocyanate group. Accordingly, the resulting binder may include a polyurethane polymer or resin. However, embodiments of the present disclosure are not limited thereto, and those of ordinary skill in the art are capable of selecting other suitable binder precursors, crosslinkers, polymers, and polymer linkages, according to the desired properties of the resultant binder or formulation of the composite propellant.

When the crosslinker is a polyisocyanate crosslinker, the polyisocyanate crosslinker may include an aliphatic diisocyanate, an aromatic diisocyanate, etc. Non-limiting examples of suitable polyisocyanate crosslinkers include methylene diphenyl diisocyanate (MDI), toluene diisocyanate, isophorone diisocyanate, hexamethylene diisocyanate, and Desmodur N-100. When the crosslinker includes a polyisocyanate, the crosslinker may be included in the formulation for the composite propellant in an amount of about 1 wt % to about 15 wt % based on 100 wt % of the formulation for the composite propellant. In some embodiments, for example, the polyisocyanate crosslinker may be included in an amount of about 2 wt % to about 8 wt %, or about 3 wt % to about 6 wt % based on 100 wt % of the formulation for the composite propellant.

In some embodiments, the crosslinker may include two or more functional groups containing an unsaturated bond, each connected to a central non-reactive group. Non-limiting examples of suitable such functional groups include alkyne groups, alkene groups (including vinyl groups), carbonyls, imines, isocyanate groups, and nitrile groups. When the crosslinker includes one or more of such functional groups, and the binder precursor includes one or more azide groups (e.g., is a polyazide), the unsaturated bond of the crosslinker may react with the azide group of the binder precursor to thereby form a triazole linkage via [2+4] cycloaddition. As used herein, the terminology “[2+4]” is used in its art-recognized sense to refer to a cycloaddition reaction involving 2 electrons from a first reactant (e.g., the unsaturated bond) and 4 electrons from a second reactant (e.g., the azide). Such reactions may also be characterized as or described by the terms “click reaction” or “1,3-dipolar cycloaddition”, wherein the azide may be described as a 1,3-dipole and the unsaturated bond may be described as a dipolarophile. However, it is to be understood that such named reactions and their proposed or commonly accepted mechanisms are referenced solely for the purpose of better illustrating the embodiments of the present disclose, and are not intended to be limiting.

In some embodiments, the crosslinker may include an acrylate functional group (e.g., a vinyl group conjugated with an ester group). For example, the crosslinker may be an alkylene diacrylate, an alkylene dimethacrylate, a polyol diacrylate, etc. Non-limiting examples of suitable crosslinkers including one or more acrylate groups include polyethylene glycol diacrylate, tetraethylene glycol diacrylate, di(ethyleneglycol) diacrylate, tetraethylene glycol dimethacrylate, tripropargyl cyanurate, etc.

In some embodiments, the functional group of the crosslinker may be a nitrile group. Non-limiting examples of suitable crosslinkers including one or more nitrite groups include polyacrylonitrile, nitrile-butadiene rubber, and other nitrile-containing rubbers.

When the nitrile or acrylate crosslinker is used with an azide binder, the crosslinker may be included in the formulation for a composite propellant in an amount of about 0.1 wt % to about 12 wt % based on 100 wt % of the composite propellant. In some embodiments, for example, the crosslinker may be included in an amount of about 0.5 wt % to about 8 wt %, or about 1 wt % to about 5 wt % based on 100 wt % of the formulation for the composite propellant.In some embodiments, the formulation for the composite propellant may further include a metal component as a fuel (e.g., an electron donor and/or oxygen atom recipient) for the oxidation reaction. The metal component may be an alkali metal, an alkaline earth metal, a transition metal, a post-transition metal, or a mixture thereof. In some embodiments, the metal component may be aluminum, magnesium, or a mixture thereof.

The metal component may be provided in the formulation as a plurality of metal particles or metal structures (e.g., metal wires, rods, mesh, etc.). The shape of the metal particles or structures is not particularly limited. For example, the metal particles may be spherical, rounded, cylindrical, cubic, plate-like, or flake-like. The sizes and shapes of the metal particles or structures are not particularly limited as long as the surface area of the particles is appropriately selected according to the desired speed of the combustion reaction.

In some embodiments, when the metal component is an aluminum powder, the aluminum powder may be 400 mesh (12 micron) German blackhead, 10 mesh (2,000 micron) bright flake, a powder having any intermediate shape and size between the two, or a mixture thereof. It will be understood that metal particles having a smaller diameter or size (and hence a larger combined surface area) will react more quickly during the combustion of the composite propellant, and those of ordinary skill in the art are capable of selecting metal particle shapes and sizes according to the principles described herein.

The metal component may be included in the formulation for a composite propellant in an amount of about 0 wt % to about 20 wt % based on 100 wt % of the formulation for the composite propellant. In some embodiments, the metal component may be included in the formulation in an amount of about 5 wt % to about 15 wt %, or about 7 wt % to about 12 wt %.

In some embodiments, the metal component may include a metallic compound such as an oxide. In some embodiments, for example, the metallic compound may retard the combustion reaction of the composite propellant. Non-limiting examples of suitable such metallic compounds include iron oxide and aluminum oxide. In some embodiments, the metallic compound may be included at a concentration between about 0.1% to about 2%. However, embodiments of the present disclosure are not limited thereto, and suitable metallic compounds may be selected according to the desired behavior of the composite propellant. In addition, formulations for composite propellants without a metallic compound are expressly included within the scope of the invention.

In some embodiments, the formulation for the composite propellant may further include a catalyst to accelerate curing of the binder. The catalyst may accelerate or increase the rate of one or more cross-coupling reactions between binder and/or cross-linker molecules. As used herein, the interchangeable terms “coupling reaction” and “cross-coupling reaction” refer to a reaction in which a new bond is formed between two previously independent molecules. Embodiments of the catalyst are not particularly limited as long as they are suitable for (e.g., active for and chemically reactive with) the particular functional groups and/or cross-coupling reactions present in the binder. In some embodiments, the catalyst may include a tertiary amine, a Group 15 compound, a transition metal compound or ion, a post-transition metal compound or ion, a transition metal particle, a post-transition metal particle, or a mixture thereof.

In some embodiments, for example, when the binder includes a polyurethane polymer or resin and/or participates in urethane linkage formation, the catalyst may be included to accelerate the reaction between the hydroxy groups in the binder and the isocyanate groups in the crosslinker. For example, the catalyst may include a dialkyl tin dicarboxylate compound (such as dibutyl tin dilaurate), a bismuth compound (such as triphenyl bismuth), or a mixture thereof. The catalyst may be included in the formulation of the composite propellant in an amount of about 0.2 wt % or less, and in some embodiments, about 0.1 wt % or less based on 100 wt % of the formulation for the composite propellant.

In some embodiments, for example, when the binder includes one or more azide groups and/or participates in a 1,3-dipolar cycloaddition reaction, as described herein, the catalyst may be included to accelerate the reaction between the dipolarophile in the crosslinker and the dipole in the binder. In some embodiments, the catalyst may include a copper salt, a ruthenium salt, a silver salt, or a mixture thereof. For example, the catalyst may include a copper(I) salt, such as copper(I) acetate, copper(I) sulfate, copper(I) chloride, copper(I) iodide, etc. The catalyst may be included in the formulation for the composite propellant in an amount of about 0.2 wt % or less, and in some embodiments, about 0.1 wt % or less based on 100 wt % of the formulation for the composite propellant. However, embodiments of the present disclosure are not limited thereto, and it is to be understood that composite propellants formed without the use of a catalyst are included within the scope of the invention.

In some embodiments, the formulation for the composite propellant may further include a sensitizer. As used herein, the term “sensitizer” is used in its art-recognized sense to refer to a material or component that promotes the propagation of the combustion reaction through the composite propellant during detonation. The sensitizer may be a chemical or a physical sensitizer, and a non-limiting example of a suitable physical sensitizer includes hollow glass microspheres.

In some embodiments, the formulation for the composite propellant may further include an energetic additive. As used herein, the term “energetic additive” refers to material that increases the amount of energy released upon compustion. A non-limiting example of a suitable energetic additive includes octahydro-1,3,5,7-tetranitro-1,3,5,7- tetrazocine (HMX). In some embodiments, the energetic additive may be included in an amount of about 2 wt % to about 15 wt %, or about 5 wt % to about 10 wt %.

According to one or more aspects of embodiments of the present disclosure, a method of preparing a composite propellant includes: mixing an oxidant and a binder to form a putty in which the oxidant is suspended or embedded in a binder matrix formed from the binder precursor, shaping the putty, and curing the putty at a temperature of 5° C. or higher. In some embodiments, the method may further include mixing a crosslinker, a metal, a sensitizer, a catalyst, or a mixture thereof with the oxidant and binder to form the putty. Each of the oxidant, the binder, the crosslinker, the metal, the sensitizer and the catalyst may be as described above in connection with the formulation for the composite propellant, and may be used in the amounts described above.

Mixing the oxidant and the binder to form a putty may include suspending solid particles of the oxidant in the binder (which may be in liquid form), and mixing the suspension in a mechanical mixer, such as a high shear mixer, a bread mixer, or a resonant acoustic mixer. In some embodiments, when a mixture of oxidants is used, the oxidants may be mixed together first, followed by addition of the binder.

When the method further includes addition of the crosslinker, the metal, the sensitizer, the catalyst, or the mixture thereof, the additional components may be added to the putty after initial mixing of the binder and oxidizer. For example, in some embodiments, the metal and/or the sensitizer may be added to the binder and oxidizer, followed by the crosslinker, and finally the catalyst. However, the order of mixing is not particularly limited, and may be selected according to the reactivity of the components. For example, when the crosslinker is a less reactive crosslinker, such as isophorone diisocyanate (e.g., the rate of reaction between the binder and crosslinker is slow enough that the crosslinking reactions will be less than about 30% completed over the timescale of mixing, and in some embodiments less than about 20% completed), the binder and the crosslinker may be pre-mixed prior to mixing with the oxidant. In some embodiments, the oxidizer may be separated into two fractions that are separately mixed with the binder and crosslinker to form two solid pastes, and the two solid pastes may be subsequently mixed together. In the interest of safety, unwetted (e.g., dry) oxidizer should not be mixed with unwetted metal components or fuels before the binder or other liquid components are added (e.g., in the absence of these liquid components).

Shaping the putty may be carried out while the putty is viscous and malleable. Shaping the putty may be achieved by any suitable method, including manually pressing the putty into a desired shape or form, extruding the putty from an extrusion apparatus, or flowing the putty into a device or receptacle under vacuum. However, embodiments of the present disclosure are not limited thereto, and it will be understood that those of ordinary skill in the art are capable of identifying and selecting alternate methods, as well as appropriate parameters for shaping the putty according to the methods described herein. When the composite propellant is to be used in oil/gas well completion, the putty may be shaped or loaded into an appropriate tool, such as a perforation gun.

Curing the putty may be carried out below and/or near room temperature (e.g., at about 5 to about 25° C.), and in some embodiments, at an elevated temperature (e.g., about 60° C.), but typically not higher than about 100° C. When the curing is carried out at an elevated temperature, the curing time may be decreased due to a concomitant increase in the kinetics (rate) of the crosslinking reactions between the binder and/or crosslinker molecules. For example, a putty that is cured over 1 to 7 days at room temperature may be cured over 2 to 10 hours at about 60° C., and a putty that is cured over 24 hours at room temperature may be cured over 4 to 6 hours at about 60° C.

After curing, the composite propellant may have a consistency between a soft rubber and a hard plastic. The composite propellant may be compatible with a variety of tool materials, including stainless steel, carbon fiber, fiberglass composites, and plastics, and may be impervious or resistant to water and other stimulants. In addition, the composite propellant may be stable at depth (e.g., at temperatures and pressures present at the desired depth within the bore hole) for a minimum of 3-4 hours, and up to several weeks or months.

The following examples and experimental data are provided for illustrative purposes only, and do not limit the scope of the embodiments of the present invention.

### EXAMPLES

### Example 1

A mixture of ammonium perchlorate particles having a diameter of 60-130 microns (41.5 wt %) or 600 microns (23 wt %) as an oxidant were combined in a mechanical mixer with liquid glycidyl azide polymer (GAP, 3M, Maplewood, Minnesota) as a binder precursor (22 wt %). Next, aluminum metal particles having a diameter of 325 mesh (9 wt %) were added, followed by methylene diphenyl diisocyanate (MDI) as a crosslinker (4.5 wt %) and dibutyl tin dilaurate (<0.1 wt %) as a curing catalyst. The reaction was mixed in a high shear mixture for 15 minutes at 20° C. to form a moldable putty. The putty was extruded into a test cylinder by mechanical pressing and allowed to cure for 7 days at 25° C.

### Example 2

A composite propellant was formulated according to substantially the same procedure as in Example 1, except that the putty was allowed to cure for 10 hours at 60° C.

### Example 3

A composite propellant was formulated according to substantially the same procedure as in Example 1, except that isophorone diisocyanate (IPDI) was used as the crosslinker instead of the methylene diphenyl diisocyanate (MDI).

### Example 4

Potassium perchlorate particles having a diameter of 100 mesh (149 pm, 80 wt %) as an oxidant were combined in a mechanical mixer with liquid hydroxy-terminated polydimethyl siloxane (PDMS, viscosity 2550-3570 cSt, Sigma-Aldrich, St. Louis, Mo.) as a binder precursor (12 wt %). Desmodur N-100 (Covestro AG, Leverkusen, Germany) as an isocyanate crosslinker (4.5 wt %) and dibutyl tin dilaurate (<0.1 wt %) as a curing catalyst were further added to the mixture. The reaction was mixed in a high shear mixture for 10 minutes at 20° C. to form a moldable putty. The putty was extruded into a plastic cylinder using vacuum to draw the mixture into the cylinder and allowed to cure for 24 hours at 25° C.

### Example 5

A composite propellant was formulated according to substantially the same procedure as in Example 4, except that the putty was allowed to cure for 6 hours at 60° C.

### Example 6

A composite propellant was formulated according to substantially the same procedure as in Example 4, except that proportional fractions of the potassium perchlorate oxidant were separately mixed with the PDMS binder precursor and the Desmodur N-100 crosslinker, and the solid pastes were subsequently combined in a high shear mixer.

### Example 7

### Click Chemistry with Acrylates

Ammonium perchlorate particles having a diameter of 60-130 pm as an oxidant (7 g, wt %) were combined in a mechanical mixer with glycidyl azide polymer as a binder precursor (1.9 g) and tetraethylene glycol diacrylate (10 mg) as a click chemistry crosslinker. The formulation was allowed to cure overnight at ambient temperature, and had cured to a hard, rubbery consistency after 24 hrs.

### Example 8

### Click Chemistry with Nitriles

A mixture of Nitrile-Butadiene Rubber (NBR) as a click chemistry crosslinker (0.15 g) and glycidyl azide polymer as a binder precursor (0.1 g) was blended in 0.5 mL acetone. Ammonium nitrate (1.3 g) and zinc nitrate (0.1 g) particles having a diameter of 200 pm and 50 pm, respectively, were subsequently added to the mixture. The mixture was cured by heating in a vacuum chamber at 100° C. for one hour to yield a hard composite.

The formulations according to Examples 1 to 8 exhibited low sensitivities to impact, spark, and friction. In addition, each was stable for about 22 hours at a temperature of about 100° C.

### Examples 9 to 18

A series of compositions were prepared with the formulations listed in Table 1.

| | Oxidant | | Crosslinker | | Energetic additive |
|---|---|---|---|---|---|
| Example | (wt %) | Binder (wt %) | (wt %) | Fuel (wt %) | (wt %) |
| Example 9 | AP (73) | HTPB (15) | MDI (2) | Al (10) | |
| Example 10 | AP (72) | HTPB (15) | MDI (2) | | HMX (10) |
| Example 11 | KP (80) | PDMS (15) | MDI (5) | | |
| Example 12 | KP (80) | PDMS (15) | TDI (5) | | |
| Example 13 | KP (80) | PDMS (12) | N-100 (8) | | |
| Example 14 | KP (75) | GAP (22.5) | MDI (2.5) | | |
| Example 15 | KP (65) | GAP (22.5) | MDI (2.5) | Al bright flake | |
| | | | | (10) | |
| Example 16 | KP (65) | GAP (22.5) | MDI (2.5) | Al German | |
| | | | | blackhead | |
| | | | | (10) | |
| Example 17 | KP (65) | GAP (22.5) | MDI (2.5) | Mg (10) | |
| Example 18 | AP (65) | GAP (22.5) | MDI (2.5) | Al bright flake | |
| | | | | (10) | |

Abbreviations:
Oxidants: AP = Ammonium Perchlorate, KP = Potassium Perchlorate
Binders: HTPB = R45M hydroxyl-terminated polybutadiene; PDMS = hydroxyl terminated polydimethylsiloxane; GAP = 3MTM GAP-5527, Glycidyl Azide Polymer
Crosslinkers: MDI = Isonate ™ 143-L modified diphenylmethane diisocyanate; TDI = Toluene diisocyanate, typically a mixture of the 2,6 and 2,4 isomers; N-100 = Desmodur N-100
Additives: HMX = Octahydro-1,3,5,7-tetranitro-1,3,5,7-tetrazocine

The stability and safety characteristics of each of the compositions of Examples 9 to 18 were tested, and the results are shown in Table 2. Impact sensitivity was tested with a Drop Hammer apparatus of Type 12B design using 150 grit sandpaper on the anvil. Data are reported in terms of drop height (cm) and correlated using the Neyer D-optimal method.

Friction testing was performed using a BAM apparatus consistent with the NATO Standardization Agreement (STANAG) 4487 standard. Data are reported in terms of the smallest load (kg) at which a reaction occurred with 50% probability according to Bruceton up/down statistical methods.

Allegany Ballistics Laboratory (ABL) Electrostatic Discharge (ESD) testing was performed at an applied voltage of 10,000 V. Data are reported in terms of the threshold initiation level (TIL) in Joules.

Differential scanning calorimetry (DSC) was performed at a ramp rate of 10° C./minute. Data are reported in terms of reaction onset temperature (° C.) and peak temperature (° C.).

TABLE 2

| | | | | DSC Onset | DSC Peak |
|---|---|---|---|---|---|
| Example | Impact | Friction (g) | ESD | (° C.) | (° C.) |
| Example 9 | 25.2 | 185 | 0.063 | 203 | 283, 359 |
| Example 10 | 22.5 | 132 | 0.125 | 194 | 264 |
| Example 11 | | | | 260 | 305 |
| Example 12 | | | | 250 | 303 |
| Example 13 | | | | 255 | 30 |
| Example 14 | | | | 215 | 25 |
| Example 15 | | | | 211 | 25 |
| Example 16 | | | | 213 | 25 |
| Example 17 | | | | 212 | 25 |
| Example 18 | 2 | 60 | 0.0625 | 220 | 26 |

The formulations according to Examples 9 to 18 were stable up to temperatures of about 190° C. In addition, all formulations were suitably insensitive to incidental energy inputs, allowing them to be safely manufactured on multi-gram scales.

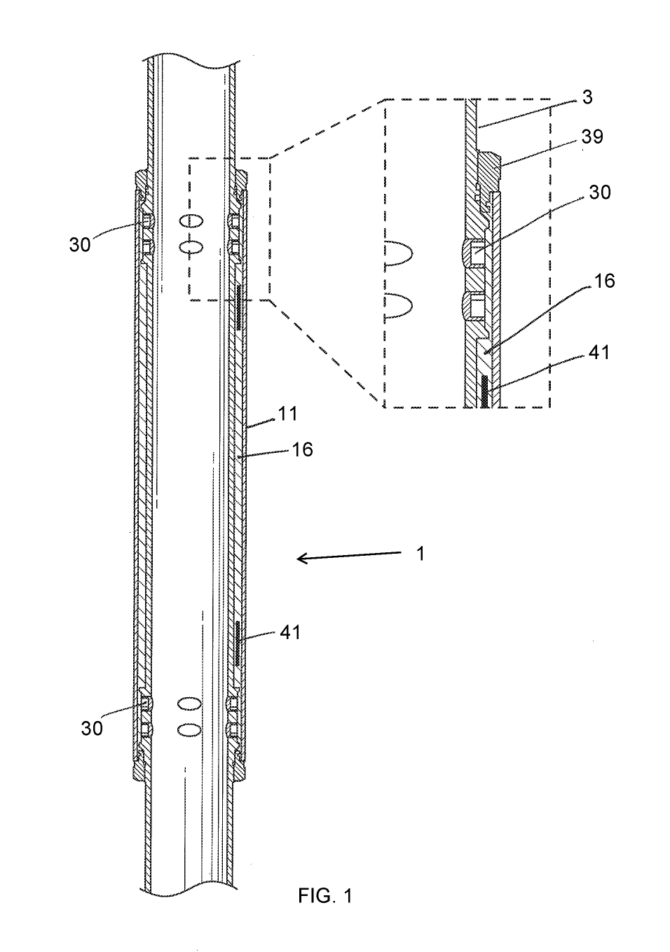

One method of employing the formulations referenced above would be in stimulating a subterranean hydrocarbon-containing formation. Generally, this method would include the steps of positioning a stimulation tool into a wellbore formed through the formation and then igniting the propellant. Example stimulation tools could be as described U.S. application Ser. No. 15/272,054 filed Sep. 21, 2016, which is incorporated by reference herein in its entirety, but employing one of the propellants described above. One embodiment of the stimulation tool could be similar to that seen in FIG. 1. FIG. 1 illustrates an embodiment of a stimulation tool (or propellant tool) 1 having at least on ignitor 41. A tubular segment 3 forms the base structure and a concentric sleeve 11 is positioned on tubular segment 3 by way of end seal rings 39, which have inner threads to engage external threads on tubular segment 3. Concentric sleeve 11 may attach to external threads on end seal rings 39 or concentric sleeve 11 may be formed on or molded to end seal rings 39. In the FIG. 1 embodiment, concentric sleeve 11 is constructed of a fiberglass material. A propellant 16 is positioned in the annular space formed between the outer surface of tubular segment 3 and concentric sleeve 11. The propellant may be any of those described previously. FIG. 1 illustrates a ignitor 41 (e.g., a titanium perchlorate igniters as disclosed above) positioned within the propellant at approximately each end of the annular space. Naturally, only one or more than two ignitors 41 could be employed in alternate embodiments depending on the burn profile to be achieved. The ignitors could be fired or ignited by an electronics package (not shown in the Figure) such as described U.S. application Ser. No. 15/272,054 filed Sep. 21, 2016, which is incorporated by reference herein in its entirety. Typically, the two ignitors 41 would be fired virtually simultaneously, e.g., within less than one millisecond of one another, but small delays between the firing of the two ignitors could be implemented to adjust the burn profile of the propellant. In a preferred embodiment, there are no high order explosives in or on the stimulation tool and there is no detonator within the sleeve or otherwise acting on the propellant. FIG. 1 shows two sets of concentrically arranged burst discs 30 positioned within the wall of tubular segment 3, with one set of burst discs 30 at approximately each end of concentric sleeve 11.

While certain exemplary embodiments of the present disclosure have been illustrated and described, those of ordinary skill in the art will recognize that various changes and modifications can be made to the described embodiments without departing from the spirit and scope of the present invention, and equivalents thereof, as defined in the claims that follow this description. For example, although certain components may have been described in the singular, i.e., “an” oxidant, “a” binder, and the like, one or more of these components in any combination can be used according to the present disclosure. Additionally, although some embodiments are described as including a polyurethane polymer or resin, it is understood that any suitable polymer or resin may be used in place of the polyurethane.

Also, although certain embodiments have been described as “comprising” or “including” the specified components, embodiments “consisting essentially of or “consisting of the listed components are also within the scope of this disclosure. For example, while embodiments of the present invention are described as comprising mixing an oxidant and a binder to form a putty, shaping the putty, and curing the putty, embodiments consisting essentially of or consisting of these actions are also within the scope of this disclosure. Accordingly, a method may consist essentially of mixing an oxidant and a binder to form a putty, shaping the putty, and curing the putty. In this context, “consisting essentially of means that any additional components or process actions will not materially affect the resulting composite propellant.

As used herein, unless otherwise expressly specified, all numbers such as those expressing values, ranges, amounts or percentages may be read as if prefaced by the word “about,” even if the term does not expressly appear. Further, the word “about” is used as a term of approximation, and not as a term of degree, and reflects the penumbra of variation associated with measurement, significant figures, and interchangeability, all as understood by a person having ordinary skill in the art to which this disclosure pertains. Any numerical range recited herein is intended to include all sub-ranges subsumed therein. Plural encompasses singular and vice versa. For example, while the present disclosure may describe “an” oxidant or “a” binder, a mixture of such oxidants or binders can be used. When ranges are given, any endpoints of those ranges and/or numbers within those ranges can be combined within the scope of the present disclosure. The terms “including” and like terms mean “including but not limited to,” unless specified to the contrary.

Notwithstanding that the numerical ranges and parameters set forth herein may be approximations, numerical values set forth in the Examples are reported as precisely as is practical. Any numerical value, however, inherently contains certain errors necessarily resulting from the standard variation found in their respective testing measurements. The word “comprising” and variations thereof as used in this description and in the claims do not limit the disclosure to exclude any variants or additions.

1. A formulation for a composite propellant comprising an oxidant suspended or embedded in a binder matrix, wherein:
(a) the oxidant comprises a nitrate anion, a perchlorate anion, a chlorate anion, a permanganate anion, a peroxide anion, or a mixture thereof, and the oxidant being included in an amount of about 50 wt % to about 85 wt %, based on 100 wt % of the formulation for the composite propellant;
(b) the binder matrix comprising a cured or partially cured binder precursor comprising at least one of, a glycidyl azide polymer (GAP), a hydroxyl-terminated dimethyl polysiloxane (PDMS), a R45M hydroxyl-terminated polybutadiene (HTPB), a polybutadiene acrylonitrile (PBAN), or a mixture thereof, the binder matrix being included in an amount of about 5 wt % to about 28 wt %, based on 100 wt % of the formulation for the composite propellant; and
(c) the formulation further comprises a crosslinker including two or more functional groups selected to complement the two or more functional groups of the binder precursor.

2. The formulation of claim 1, wherein the perchlorate compound comprises sodium perchlorate, potassium perchlorate, ammonium perchlorate, or a mixture thereof.

3. The formulation of claim 1, wherein the crosslinker comprises a polyisocyanate selected from methylene diphenyl diisocyanate (MDI), toluene diisocyanate, isophorone diisocyanate, hexamethylene diisocyanate, Desmodur N-100, or a mixture thereof.

4. The formulation of claim 1, wherein the crosslinker comprises a tetraethylene glycol diacrylate, a Nitrile-Butadiene Rubber (NBR), or a mixture thereof.

5. The formulation of claim 1, further including a metal component selected from an alkali metal, an alkaline earth metal, a transition metal, a post-transition metal, or a mixture thereof.

6. The formulation of claim 5, wherein the metal component comprises aluminum, magnesium, or a mixture thereof.

7. The formulation of claim 1, further comprising a catalyst for accelerating one or more cross-coupling reactions between the binder and the crosslinker.

8. The formulation of claim 7, wherein the catalyst comprises dibutyl tin dilaurate, triphenyl bismuth, a copper(I) salt, or a mixture thereof.

9. A method of preparing a composite propellant, comprising:
mixing an oxidant and a binder precursor to form a putty in which the oxidant is suspended or embedded in a binder matrix formed from the binder precursor; shaping the putty; and curing the putty at a temperature of 5° C. or higher.

10. The method of claim 9, wherein the oxidant comprises a nitrate compound, a perchlorate compound, a chlorate compound, a permanganate compound, a peroxide compound, or a mixture thereof.

11. The method of claim 10, wherein the perchlorate compound comprises sodium perchlorate, potassium perchlorate, ammonium perchlorate, or a mixture thereof.

12. The method of claim 9, wherein the binder precursor comprises a glycidyl azide polymer (GAP), a hydroxyl-terminated dimethyl polysiloxane (PDMS), a R45M hydroxyl-terminated polybutadiene (HTPB), a polybutadiene acrylonitrile (PBAN), or a mixture thereof.

13. The method of claim 9, further comprising mixing the oxidant and the binder precursor with a crosslinker.

14. The method of claim 13, wherein the crosslinker comprises a polyisocyanate selected from methylene diphenyl diisocyanate (MDI), toluene diisocyanate, isophorone diisocyanate, hexamethylene diisocyanate, Desmodur N-100, or a mixture thereof.

15. The method of claim 13, wherein the crosslinker comprises a tetraethylene glycol diacrylate, Nitrile-Butadiene Rubber (NBR), or a mixture thereof.

16. The method of claim 9, wherein curing the putty is carried out at about 60° C. to about 100° C.

17. A method of stimulating a subterranean hydrocarbon-containing formation comprising the steps of:
(a) positioning a stimulation tool into a wellbore formed through the formation, the stimulation tool comprising:
(i) at least one tubular segment;
(ii) an outer sleeve positioned on the tubular segment;
(iii) a propellant positioned within the sleeve;
(iv) an ignitor positioned to ignite the propellant;
(v) wherein the propellant comprises an oxidant suspended or embedded in a binder matrix, wherein:
(1) the oxidant comprises a nitrate anion, a perchlorate anion, a chlorate anion, a permanganate anion, a peroxide anion, or a mixture thereof, and the oxidant being included in an amount of about 50 wt % to about 85 wt %, based on 100 wt % of the formulation for the composite propellant;
(2) the binder matrix comprising a cured or partially cured binder precursor comprising at least one of, a glycidyl azide polymer (GAP), a hydroxyl-terminated dimethyl polysiloxane (PDMS), a R45M hydroxyl-terminated polybutadiene (HTPB), a polybutadiene acrylonitrile (PBAN), or a mixture thereof, the binder matrix being included in an amount of about 5 wt % to about 28 wt %, based on 100 wt % of the formulation for the composite propellant ; and
(3) the formulation further comprises a crosslinker including two or more functional groups selected to complement the two or more functional groups of the binder precursor.
(b) igniting the propellant to begin deflagration of the propellant.

18. The formulation of claim 17, wherein the perchlorate compound comprises sodium perchlorate, potassium perchlorate, ammonium perchlorate, or a mixture thereof.

19. The formulation of claim 17, wherein the crosslinker comprises a polyisocyanate selected from methylene diphenyl diisocyanate (MDI), toluene diisocyanate, isophorone diisocyanate, hexamethylene diisocyanate, Desmodur N-100, or a mixture thereof.

20. The formulation of claim 17, wherein the crosslinker comprises a tetraethylene glycol diacrylate, a Nitrile-Butadiene Rubber (NBR), or a mixture thereof.

21-25. (canceled)
